(19) United States
(12) Patent Application Publication
(10) Pub. No.: US 2025/0354501 A1
(43) Pub. Date: Nov. 20, 2025

(54) UNDUCTED THRUST-GENERATING ASSEMBLY COMPRISING AN OUTER GUIDE VANE

(71) Applicant: SAFRAN AIRCRAFT ENGINES, Paris (FR)

(72) Inventors: Guillaume Claude Robert BELMON, Moissy-Cramayel (FR); Julien Michel TANMIZIER, Moissy-Cramayel (FR); Anthony BINDER, Moissy-Cramayel (FR)

(73) Assignee: SAFRAN AIRCRAFT ENGINES, Paris (FR)

(21) Appl. No.: 18/872,512

(22) PCT Filed: Jun. 7, 2023
(86) PCT No.: PCT/FR2023/050804

§ 371 Date: Jan. 2, 2025

(30) Foreign Application Priority Data
Jun. 8, 2022 (FR) FR2205479

(51) Int. Cl. F01D 25/24; F01D 5/02

(52) U.S. Cl. CPC F01D 25/24; F01D 5/021

(57) ABSTRACT

The present invention relates to a flow-straightening stator (5) of an unducted thrust-generating assembly (3) comprising a plurality of blades (7) each having: —a tip (11) and a radially inner boundary (10) corresponding to an intersection between the blade (7) and a casing (8) of the turbine engine (1); —a skeleton (16); and—a deviation (S) of the profile, corresponding to an absolute value of a difference between a tangent to the skeleton (16) at the leading edge (14) and a tangent to the skeleton (16) at the trailing edge (15) of the blade (7), of between 20° and 450 at the radially inner boundary (10) of the blade (7) and between 10° and 40° at the tip (11) of the blade (7).

### TECHNICAL FIELD

The present application generally relates to the field of turbine engines, and more particularly to the outer guide vane of an unducted thrust-generating assembly for a turbine engine. The application applies more particularly, but in a non-limiting manner, to turbine engines having a high bypass ratio (typically greater than 12, preferably greater than 18).

### STATE OF THE ART

A USF (acronym for Unducted Single Fan) type turbine engine comprises, from upstream to downstream in the direction of gas flow through the turbine engine, a rotating propeller and an outer guide vane.

Generally speaking, a propeller called “conventional” single-stage turboprop propeller as well as the contra-rotating propeller pairs are loaded at the upper part of the blades, maximizing the work of this part of the blade to increase the flow deviation. In fact, this allows to take advantage of the speed triangulation at the blade head, which is favorable to the driving thrust. Moreover, this allows to minimize the induced losses of the blade, that is to say the losses generated by the radial distribution of the blade load, which can be materialized by a vortex at the blade head and generally by a modification of the triangulation of the air flow, which tends to reduce the driving thrust.

The Applicant noticed that loading the propeller at the blade head also had the effect of loading the outer guide vane at the blade tip. The increase in the load means that the deviation increases, that the residual gyration at the propeller outlet also increases, and therefore that the outer guide vane must make a strong deviation to re-axialize the air flow. However, the solidity of an outer guide vane is lower in this zone of the blade. By solidity at a given radius of the outer guide vane, it will be understood here that the ratio between the chord of the blade and the distance between two adjacent blades (the chord and the distance being measured at the radius in question). However, the lower the solidity of an outer guide vane, the less the outer guide vane is able to straighten the flow, which implies a decrease in aerodynamic performance, an increase in the noise level from an acoustic point of view (due to the interaction between the propeller and the outer guide vane at the blade tips) and high mechanical stresses in the outer guide vane at the blade tip.

In order to eliminate noise at the head of unducted blades, document FR2938502 proposes to equip the blades of the propeller with guide fins. However, this document relates to a turbine engine comprising counter-rotating propellers, and not a propeller followed by an outer guide vane. In addition, the proposed solution has the effect of deviating the vortices radially outside the downstream blading: consequently, the application of this solution to a thrust-generating assembly comprising a static outer guide vane has the effect of reducing the quantity of air flow straightened by the outer guide vane and therefore the aerodynamic performance of the turbine engine.

### DISCLOSURE OF THE INVENTION

A purpose of the present application is to overcome the aforementioned disadvantages, by proposing an outer guide vane capable of improving the aerodynamic performance of the turbine engine and of reducing the noise generated by the thrust-generating assembly, without increasing the mechanical stresses at the blade tip of the outer guide vane.

For this purpose, according to a first aspect, provision is made of an outer guide vane of an unducted thrust-generating assembly for a turbine engine comprising a plurality of blades each having:
a tip and a radially inner boundary corresponding to an intersection between the blade and a casing of the turbine engine;
a skeleton corresponding to an imaginary line extending from a leading edge to a trailing edge of the blade, equidistant between a pressure surface and a suction surface of the blade; and
a deviation (δ) of the profile, corresponding to an absolute value of a difference between a tangent to the skeleton at the leading edge and a tangent to the skeleton at the trailing edge of the blade, of between 20° and 45° at the radially inner boundary of the blade and between 10° and 40° at the tip of the blade.

In one embodiment, the maximum deviation value is obtained between 0% and 40% of the height of the blade (the height is understood as the difference between the maximum radius at the blade tip and the minimum radius of the intersection between the blade and the casing of the turbine engine).

Some preferred but non-limiting features of the outer guide vane according to the first aspect are as follows, taken individually or in combination:
the deviation of the profile of each blade at the radially inner boundary of the blade is of between 25° and 35°;
a minimum deviation of the profile of each blade is located at a distance from the radially inner boundary of the blade of between 40% and 100%, preferably between 40% and 85%, of the height of the blade;
the deviation of the profile of each blade decreases from the radially inner boundary of the blade towards the tip of the blade over at least 50% of the height of the blade, preferably over at least 70% of the height of the blade, for example over about 80% of the height of the blade;
the deviation of the profile of each blade decreases from the radially inner boundary of the blade towards the tip of the blade to a first zone of the blade extending at a distance from the radially inner boundary of the blade of between 45% of the height of the blade and 85% of the height of the blade, preferably between 70% of the height of the blade and 85% of the height of the blade;
the deviation of the profile of each blade increases from the first zone of the blade to the tip of the blade;
the deviation of the profile of each blade is greater than 20° over at least a portion of the blade extending from the radially inner boundary of the blade to a second zone of the blade extending at a distance of between 0% and 40% of the height of the blade;
the deviation of the profile of each blade at the radially inner boundary of the blade is strictly greater than the deviation of the profile at the tip of the blade;
a maximum deviation of the profile of each blade is located at a distance from the radially inner boundary of the blade of between 0% and 40% of the height of the blade;
the deviation of the profile of each blade is less than 25° over a portion of the blade extending from the radially inner boundary to a distance of between 40% and 80% of the height of the blade;
the deviation of the profile of each blade at the tip of the blade is of between 10° and 25°;
the first zone of the blade extends at a distance from the radially inner boundary of the blade of between 45% of the height of the blade and 75% of the height of the blade, preferably between 50% of the height of the blade and 70% of the height of the blade;
the deviation of the profile of each blade is less than 25° over a portion of the blade extending from a first distance of between 10% and 20% of the height of the blade to a second distance of between 80% and 100% of the height of the blade;
the deviation of the profile of each blade at the tip of the blade is of between 25° and 35°;
the deviation of the profile of each blade is strictly greater than 20° over the entire height of the blade;
the deviation of the profile of each blade at the tip of the blade is greater than or equal to the deviation of the profile at the radially inner boundary of the blade;
the outer guide vane comprises between 8 and 12 blades; and/or
a length of the chord of each blade at the tip of the blade is less than 75% of a maximum chord of the blade.

According to a second aspect, the invention proposes an unducted thrust-generating assembly for a turbine engine comprising a propeller rotatable relative to a casing of the turbine engine and an outer guide vane fixedly mounted according to the first aspect on the casing and extending downstream of the propeller.

The propeller can comprise between ten and sixteen rotating blades. The outer guide vane can comprise between eight and fourteen blades.

According to a third aspect, provision is made of a turbine engine comprising a casing and an unducted thrust-generating assembly according to the second aspect, the propeller being rotatable relative to the casing and the outer guide vane being fixed in rotation relative to the casing.

At least one of the propeller and the outer guide vane has a variable pitch. Preferably, the propeller and the outer guide vane have a variable pitch.

According to a fourth aspect, provision is made of an aircraft comprising a turbine engine according to the third aspect.

### DESCRIPTION OF THE FIGURES

Other features, purposes and advantages of the invention will emerge from the description which follows, which is purely illustrative and non-limiting, and which must be read in conjunction with the appended drawings in which:

FIG. 1 schematically illustrates an example of a USF type turbine engine in accordance with an embodiment of the invention;

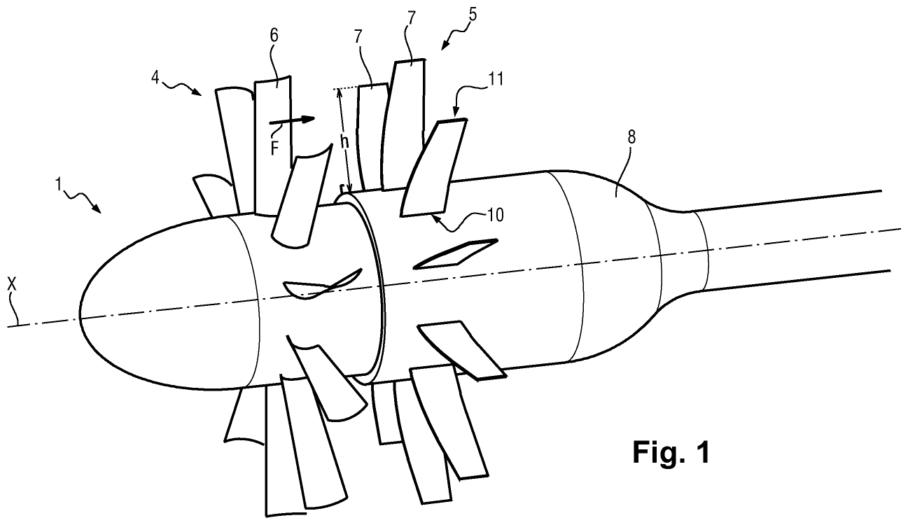

FIG. 2 is a schematic sectional view (in a plane normal to an axis radial to the axis of the turbine engine) of an example of an outer guide vane blade in accordance with an exemplary embodiment of the invention;

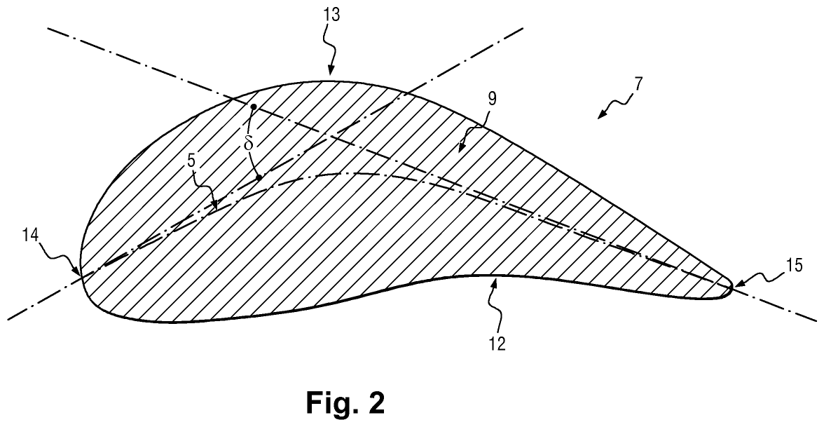

FIG. 3 shows the deviation (δ, in degrees) of exemplary embodiments of an outer guide vane blade according to the invention, as a function of the distance (% h) from the radially inner boundary of this blade; and

FIG. 4 schematically shows an aircraft comprising two turbine engines in accordance with one embodiment of the invention.

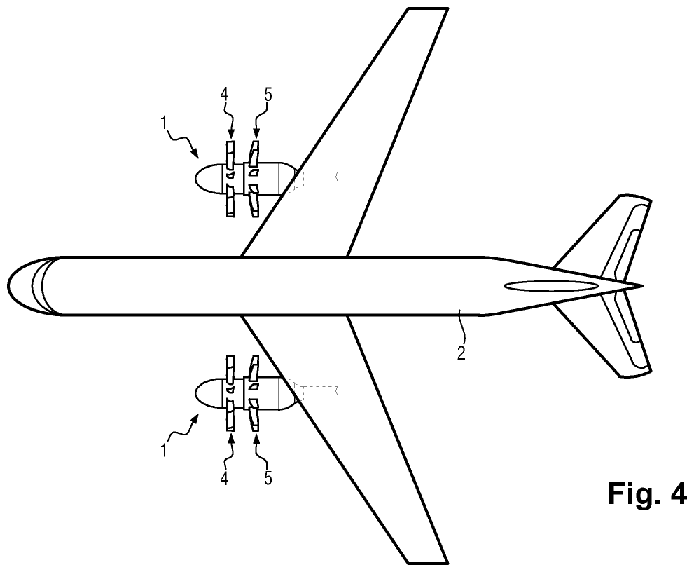

In all figures, similar elements bear identical references.

### DETAILED DESCRIPTION OF THE INVENTION

A turbine engine 1, in particular an aircraft 2 turbine engine, has a main direction extending along a longitudinal axis X and typically includes, from upstream to downstream in the direction of gas flow, a thrust-generating assembly 3 and a gas generator. The gas generator may comprise a compression section which may comprise a low-pressure compressor and a high-pressure compressor, a combustion chamber, a turbine section which may comprise a high-pressure turbine and a low-pressure turbine, and an exhaust casing.

The thrust-generating assembly 3 is preferably unducted, that is to say it is not surrounded by an external nacelle or a fairing of the turbine engine 1. It comprises a propeller 4 (rotor) mounted rotatable about the axis X and outer guide vanes 5 (stator), coaxial with the propeller 4 and mounted at the outlet of the propeller 4, immediately downstream thereof. In one embodiment, the propeller 4 is a variable-pitch propeller and comprises a pitch-changing mechanism configured to pivot each blade of the propeller 4 about a respective pivot axis, which is radial to the axis X of rotation of the propeller 4.

The outer guide vanes 5 have the function of axially straightening the air flow F which is rotated by the propeller 4. Indeed, the propeller 4 generates a gyration of the flow downstream, where the gyration is the tangential velocity component of the flow (in a cylindrical reference frame whose main axis X corresponds to the engine axis X). This component is zero upstream of the propeller 4 and appears due to the rotational drive of the flow by the propeller 4. The (static) outer guide vanes 5 then have the function of cancelling this component and redirecting it in the axial direction, since any non-zero tangential velocity component has the effect of reducing the thrust generated by the engine and increasing its losses.

The propeller 4 may comprise between ten and sixteen blades 6. The outer guide vanes 5 may comprise between eight and fourteen vanes 7. The vanes 7 of the outer guide vanes 5 and of the propeller 4 may be made of any suitable material, for example metal or a composite material comprising a fibrous reinforcement densified by a matrix, typically a polymer resin.

In the present application, the axial direction corresponds to the direction of the axis X and a radial direction is a direction perpendicular to this axis X and passing therethrough. Moreover, the circumferential direction corresponds to a direction perpendicular to the axis X and not passing therethrough. Unless otherwise specified, inner (respectively, internal) and outer (respectively, external), respectively, are used with reference to a radial direction such that the inner part or face of an element is closer to the axis X than the outer part or face of the same element.

The outer guide vanes 5 comprises stator vanes 7, fixedly mounted on an outer casing 8 of the turbine engine 1, typically the casing which surrounds the generator. In the case of an unducted propulsion unit 3, the outer casing 8 corresponds to the nacelle which surrounds the generator. Each vane 7 has for this purpose a root mounted in the outer casing 8 and an airfoil 9 with an aerodynamic profile suitable for being placed in an air flow F when the turbine engine 1 is in operation in order to straighten the air flow F at the outlet of the propeller 4.

The vane 7 has a radially inner boundary 10, which corresponds to the intersection between the nacelle 8 and the vane 7, and a tip 11 at its free end and which corresponds to a radially outer boundary of the vane 7. The radially outer boundary of the vane 7 therefore radially delimits the flow passing through the outer guide vanes 5.

The vane 7 further has a pressure surface 12, a suction surface 13, a leading edge 14 and a trailing edge 15. In a manner known per se, the leading edge 14 is configured to extend opposite the flow of gases entering the outer guide vanes 5. It corresponds, in normal operation out of thrust reversal mode, to the front part of an aerodynamic profile which faces the air flow F and which divides the air flow into a pressure surface flow 12 and a suction surface flow 13. The trailing edge 15 corresponds to the rear part of the aerodynamic profile, where the pressure surface and suction surface flows meet.

In order to improve the aerodynamic performance of the turbine engine 1 and to reduce the noise generated by the thrust-generating assembly 3, it is appropriate to unload the tip 11 of the vanes 7. Indeed, the recovery of the forces is thus maximized in the zone where the outer guide vanes 5 have a higher solidity, typically at the radially inner boundary 10 of the vane 7. The tip 11 of the vanes 7 being less loaded, this also allows to reduce the noise generated by the vortices at the blade tip 7, the propeller 4-outer guide vanes 5 wake interaction noise, as well as the inherent noise of the propeller 4 and the outer guide vanes 5 at the blade tip 7. The aero-acoustic performance of the outer guide vanes 5 is therefore increased while improving the distribution of the mechanical stresses in the vanes 7 by reducing the aerodynamic forces at the blade tip.

Several structural parameters of the vanes 7 of the outer guide vanes 5 can be taken into account in this regard, including a dihedral and a deviation δ of the profile of each vane 7. The consideration of the dihedral is described in more detail in document FR3124832, in the name of the Applicant. The deviation δ of the profile of the vane 7 corresponds to an absolute value of a difference between a tangent to the skeleton 16 at the leading edge 14 and a tangent 16 to the skeleton at the trailing edge 15 of the vane 7. Skeleton 16 means here the imaginary line extending from the leading edge 14 to the trailing edge 15 of the vane 7, equidistant between a pressure surface 12 and a suction surface 13 of the vane 7.

In the turbine engine 1, each vane 7 of the outer guide vanes 5 is shaped such that a deviation δ of the profile of the vane 7 is of between 20° and 45°, preferably between 25° and 35°, at the radially inner boundary 10 of the vane 7 and between 10° and 40° at the tip 11 of the vane 7. This configuration of the vanes 7 allows, in particular, to maximize the deviation of the air flow F passing through the outer guide vanes 5 at the bottom of the vane (that is to say in the zone extending close to the radially inner boundary 10 of the vanes 7), rather than at the tip 11, which relieves the tip 11 of the vane 7.

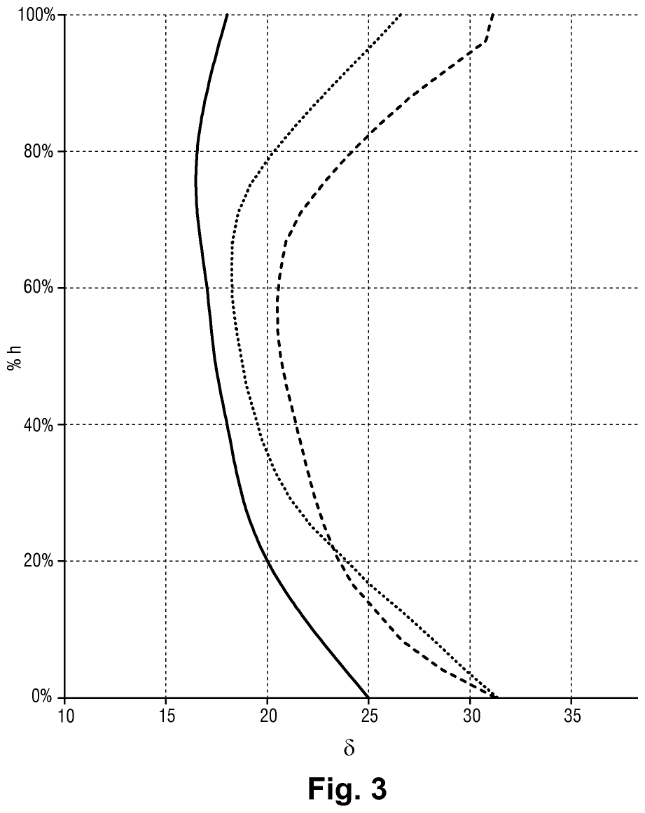

Several profile shapes of the vane 7 can be considered, as illustrated in FIG. 3. It should be noted that, for reasons of simplicity of manufacture, each vane 7 of the outer guide vanes 5 preferably has substantially the same profile shape (within manufacturing tolerances). This is however not limiting since the vanes 7 can have different profiles within the same outer guide vanes 5.

Regardless of the considered shape, a minimum deviation δₘᵢₙ of the vane 7 is advantageously located at a distance (% h in FIG. 3) from the radially inner boundary 10 of the vane 7 of between 40% and 100% of the height h of the vane 7, that is to say in the part of the vane 7 which is adjacent to the tip 11. Height h of the vane 7 means here the distance (measured along a radial axis of the vane 7 passing through the tip 11) between the radially inner boundary 10 and the tip 11 of the vane 7. For example, the minimum deviation δₘᵢₙ of the profile can be located at a distance equal to approximately 80% (to within 5%) of the height h of the vane 7 (solid curve in FIG. 3). This is not, however, limiting since a minimum deviation δₘᵢₙ of the vane 7 may also be located at a distance from the radially inner boundary 10 of the vane 7 of between 40% and 85% of the height h of the vane 7, that is to say in a median portion of the vane 7. For example, the minimum deviation δₘᵢₙ of the profile may be located at a distance equal to approximately 65% (to within 5%) of the height h of the vane 7 (dotted curve in FIG. 3) or at a distance equal to approximately 55% (to within 5%) of the height h of the vane 7 (dashed curve in FIG. 3).

Moreover, the deviation δ of the profile of each vane 7 advantageously decreases from the radially inner boundary 10 of the vane 7 towards the tip 11 of the vane 7 over at least 50% of the vane 7, preferably over at least 70% of the height h of the vane 7, for example over approximately 80% of the height h of the vane 7. Preferably, it decreases from the radially inner boundary 10 of the vane 7 towards the tip 11 of the vane 7 to a zone of the vane 7 extending at a distance from the radially inner boundary 10 of the vane 7 of between 45% of the height h of the vane 7 and 85% of the height h of the vane 7, for example of between 70% of the height h of the vane 7 and 85% of the height h of the vane 7. In certain embodiments (dotted and dashed curves in FIG. 3), it decreases from the radially inner boundary 10 of the vane 7 towards the tip 11 of the vane 7 to a zone of the vane 7 extending at a distance from the radially inner boundary 10 of the vane 7 of between 45% of the height h of the vane 7 and 75% of the height h of the vane 7, for example of between 50% of the height h of the vane 7 and 20% of the height h of the vane 7. Where appropriate, it may then increase up to the tip 11 of the vane 7. Thus, the deviation δ decreases over a part, or even the majority, of the height h of the vane 7, from its radially inner boundary 10. Then it increases.

Furthermore, the deviation δ of the profile of each vane 7 is advantageously greater than 15°, preferably greater than 20°, at least at the bottom of the airfoil 9, for example on a portion of the vane 7 extending from the radially inner boundary 10 of the vane 7 to a zone of the vane 7 extending at a distance of between 0% and 40% of the height h of the vane 7. In certain embodiments, the deviation δ of the profile of each vane 7 is also greater than 20° at the top of the airfoil 9, for example on a portion of the blade extending from a zone of the vane 7 extending at a distance of between 70% and 80% of the height h of the vane 7 to the tip 11 of the vane 7 (dotted curve in FIG. 3). Where appropriate, the deviation δ of the profile of each vane 7 may even be strictly greater than 20° over the entire height h of the vane 7 (dashed curve in FIG. 3).

In some embodiments, the deviation δ of the profile of each vane 7 at the radially inner boundary 10 of the vane 7 is strictly greater than the deviation δ of the profile at the tip 11 of the vane 7 in order to maximize the deviation of the air flow F at the bottom of the airfoil 9 (solid and dotted curves in FIG. 3). Where appropriate, the dihedral of the vane 7 is advantageously inclined towards the pressure surface 12. Furthermore, the smaller deviation at the head allows to obtain outer guide vanes 5 the vanes 7 of which have a chord at the tip (that is to say at the tip 11 of the blade) smaller than the chord at the root (that is to say at the radially inner boundary 10), which allows to further reduce losses. Moreover, a length of the chord at the head of each vane 7 is preferably less than 75% of a maximum chord of the vane 7 over the height of the vane 7. This is however not limiting, since the deviation δ of the profile of each vane 7 at the tip 11 of the vane 7 can alternatively be greater than or equal to the deviation δ of the profile at the radially inner boundary 10 of the vane 7. Where appropriate, the dihedral is advantageously neutral, or even inclined towards the suction surface 13.

Furthermore, the maximum deviation δₘₐₓ of the profile of each vane 7 is advantageously located at a distance from the radially inner boundary 10 of the vane 7 of between 0% and 40% of the height h of the vane 7. For example, the maximum deviation δₘₐₓ of the profile may be located at the radially inner boundary 10 (solid and dotted curves in FIG. 3). In certain cases, the maximum deviation δₘₐₓ of the profile is located in the first third of the height h of the vane 7 and the minimum deviation δₘᵢₙ in the last third (solid curve in FIG. 3).

Moreover, the deviation δ of the profile of each vane 7 is advantageously less than 25° at the top of the airfoil 9, for example on a portion of the vane 7 extending from the radially inner boundary 10 to a distance of between 40% and 80% of the height h of the vane 7 (solid and dotted curves in FIG. 3). Alternatively, the deviation δ of the profile of each vane 7 may be less than 25° on a portion of the vane 7 extending from a first distance of between 10% and 20% of the height of the vane 7 to a second distance of between 80% and 100% of the height of the vane 7 (dotted and dashed curves in FIG. 3).

The solid curve illustrated in FIG. 3 corresponds to a deviation δ of the profile of the vane 7 in which the maximum deviation δₘₐₓ is of the order of 25° and is located at the radially inner boundary 10 of the vane 7. Furthermore, the deviation δ decreases from the radially inner boundary 10 of the vane 7 over a distance equal to 75%-80% of the height h of the vane 7, where it reaches a minimum of the order of 17°. The decrease in the deviation δ is continuous over the entire height h of the vane 7 until reaching its minimum δₘᵢₙ. Then, it increases up to the tip 11 of the vane 7, where it is of between 10° and 25°, preferably substantially equal to 18°.

The dotted curve illustrated in FIG. 3 corresponds, in turn, to a deviation δ of the profile of the vane 7 in which the maximum deviation δₘₐₓ is greater than 30°, and preferably substantially equal to 32°, and is located at the radially inner boundary 10 of the vane 7. Furthermore, the deviation δ decreases from the radially inner boundary 10 of the vane 7 over a distance equal to 60%-65% of the height h of the vane 7, where it reaches a minimum of the order of 18°. The decrease in the deviation δ is continuous over the entire height h of the vane 7 until reaching its minimum δₘᵢₙ. Then it increases up to the tip 11 of the vane 7, where it is of between 25° and 30°, preferably substantially equal to 27°.

As for the dashed curve illustrated in FIG. 3, it corresponds to a deviation δ of the profile of the vane 7 in which the maximum deviation δₘₐₓ is greater than 30°, and preferably substantially equal to 32°, and is located at the radially inner boundary 10 of the vane 7 but also at the tip 11 of the vane 7. Furthermore, the deviation δ decreases from the radially inner boundary 10 of the vane 7 over a distance equal to 55%-60% of the height h of the vane 7, where it reaches a minimum of the order of 21°. The decrease in the deviation δ is continuous over the entire height h of the vane 7 until reaching its minimum δₘᵢₙ. Then it increases up to the tip 11 of the vane 7.

It will be noted that the height h of the vanes 7 of the outer guide vanes 5 can be substantially equal to a height of the blades 6 of the propeller 4, where the height of the blades 6 of the propeller 4 corresponds to the distance (measured along the pivot axis of the blade 6 or where appropriate an axis radial to the axis X passing through its tip) between a radially inner boundary 10 of the blade 6 and the tip of the blade 6.

Alternatively, the height h of the vanes 7 of the outer guide vanes 5 may be less than the height of the blades 6 of the propeller 4.

1. Outer guide vanes of an unducted thrust-generating assembly for a turbine engine, the outer guide vanes comprising a plurality of vanes each having:
a tip and a radially inner boundary corresponding to an intersection between the vane and a casing of the turbine engine;
a skeleton corresponding to an imaginary line extending from a leading edge to a trailing edge of the vane, the skeleton being equidistant between a pressure surface and a suction surface of the vane; and
a deviation of a profile of the vane, the deviation corresponding to an absolute value of a difference between a tangent to the skeleton at the leading edge and a tangent to the skeleton at the trailing edge of the vane, of between 20° and 45° at the radially inner boundary of the vane and between 10° and 40° at the tip of the vane.

2. The outer guide vanes according to claim 1, wherein the deviation of the profile of each vane at the radially inner boundary of the vane is of between 250 and 35°.

3. The outer guide vanes according to claim 1, wherein a minimum deviation of the profile of each vane is located at a distance from the radially inner boundary of the vane of between 40% and 100%.

4. The outer guide vanes according to claim 1, wherein the deviation of the profile of each vane decreases from the radially inner boundary of the vane towards the tip of the vane over at least 50% of the height of the vane.

5. The outer guide vanes according to claim 4, wherein the deviation of the profile of each vane decreases from the radially inner boundary of the vane towards the tip of the vane to a first zone of the vane extending at a distance from the radially inner boundary of the vane of between 45% of the height of the vane and 85% of the height of the vane.

6. The outer guide vanes according to claim 5, wherein the deviation of the profile of each vane increases from the first zone of the vane to the tip of the vane.

7. The outer guide vanes-(53 according to claim 1, wherein the deviation of the profile of each vane is greater than 20° over at least a portion of the vane extending from the radially inner boundary of the vane to a second zone of the vane extending at a distance of between 0% and 40% of the height of the vane.

8. The outer guide vanes according to claim 1, wherein the deviation of the profile of each vane at the radially inner boundary of the vane is strictly greater than the deviation of the profile at the tip of the vane.

9. The outer guide vanes according to claim 1, wherein a maximum deviation of the profile of each vane is located at a distance from the radially inner boundary of the vane of between 0% and 40% of the height of the vane.

10. The outer guide vanes according to claim 1, wherein the deviation of the profile of each vane is less than 25° over a portion of the vane extending from the radially inner boundary to a distance of between 40% and 80% of the height of the vane.

11. The outer guide vanes according to claim 1, wherein the deviation of the profile of each vane at the tip of the vane is of between 10° and 25°.

12. The outer guide vanes according to claim 5, wherein the first zone of the vane extends at a distance from the radially inner boundary of the vane of between 45% of the height of the vane and 75% of the height of the vane, preferably between 50% of the height of the vane and 70% of the height of the vane.

13. The outer guide vanes according to claim 1, wherein the deviation of the profile of each vane is less than 25° over a portion of the vane extending from a first distance of between 10% and 20% of the height of the vane to a second distance of between 80% and 100% of the height of the vane.

14. The outer guide vanes according to claim 1, wherein the deviation of the profile of each vane at the tip of the vane is of between 25° and 35°.

15. The outer guide vanes according to claim 1, wherein the deviation of the profile of each vane is strictly greater than 20° over the entire height of the vane.

16. The outer guide vanes according to claim 1, wherein the deviation of the profile of each vane at the tip of the vane is greater than or equal to the deviation of the profile at the radially inner boundary of the vane.

17. The outer guide vanes according to claim 1, comprising between 8 and 12 vanes.

18. The outer guide vanes according to claim 1, wherein a length of the chord of each vane at the tip of the vane is less than 75% of a maximum chord of the vane.

19. An unducted thrust-generating assembly for a turbine engine comprising:
a propeller rotatable relative to a casing of the turbine engine; and
the outer guide vanes according to claim 1 fixedly mounted on the casing and extending downstream of the propeller.

20. The assembly according to claim 19, wherein the propeller comprises between ten and sixteen rotating blades.

21. A turbine engine comprising:
a casing; and
the unducted thrust-generating assembly according to claim 19, the propeller being rotatable relative to the casing and the outer guide vanes being fixed in rotation relative to the casing, downstream of the propeller.

22. The turbine engine according to claim 21, wherein at least one of the propeller and the outer guide vanes has a variable pitch.
